(19) United States
(12) Patent Application Publication
(10) Pub. No.: US 2009/0287342 A1
(43) Pub. Date: Nov. 19, 2009

(54) Molding Machine Management System, Molding Machine, Management Apparatus, and Molding Machine Management Method

(75) Inventor: Katsunobu Hano, Chiba (JP)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: SUMITOMO HEAVY INDUSTRIES, LTD.

(21) Appl. No.: 12/086,154

(22) PCT Filed: Dec. 7, 2006
(86) PCT No.: PCT/JP2006/324431

§ 371 Date: Jun. 6, 2008

(30) Foreign Application Priority Data
Dec. 13, 2005 (JP) 2005-358477

(51) Int. Cl. G06F 19/00

(52) U.S. Cl. 700/204

(57) ABSTRACT

An object is to facilitate protection of data and suppress communication loads imposed on a network, molding machines, etc. A molding machine management system includes a management apparatus for managing a plurality of molding machines. The system comprises an information recording processing section which records on a recording device reference data acquired by operating each molding machine; an information manipulation processing section which performs predetermined processing on the reference data and actual data acquired by operating each molding machine to thereby obtain manipulated data; an information transmission processing section which transmits the reference data to the management apparatus in advance and transmits the manipulated data to the management apparatus as needed; and an information synthesis processing section which synthesizes the reference data and the manipulated data. Since the data obtained by operating each molding machine are recorded in the recording device of the molding machine, protection of the data becomes easier. After the reference data are sent from each molding machine to the management apparatus, only the manipulated data should be sent from each molding machine to the management apparatus. Consequently, there is no need for performing communication between the management apparatus and each of the molding machines at all times.

### TECHNICAL FIELD

The present invention relates to a molding machine management system, a molding machine, a management apparatus, and a molding machine management method.

### BACKGROUND ART

Conventionally, in a molding machine; for example, in an injection molding machine, resin heated and melted in a heating cylinder is injected under high pressure and is charged into a cavity of a mold apparatus, and the injected resin is cooled and solidified in the cavity. Subsequently, the solidified resin is taken out as a molded product.

The injection molding machine includes the mold apparatus, a mold-clamping apparatus, an injection apparatus, etc. The mold-clamping apparatus includes a stationary platen and a movable platen. The movable platen is advanced and retreated through drive of a mold-clamping motor to thereby perform mold closing, mold clamping, and mold opening.

Meanwhile, the injection apparatus includes a heating cylinder for heating and melting resin fed from a hopper, and an injection nozzle for injecting the molten resin. A screw is disposed in the heating cylinder such that the screw can rotate and can advance and retreat. When the screw is rotated through drive of a metering motor, metered resin is accumulated forward of the screw within the heating cylinder. When the screw is advanced through drive of an injection motor, the resin accumulated forward of the screw is injected and charged into a cavity of the mold apparatus in a clamped state.

When mold opening is performed after the resin within the cavity is cooled to complete a molded product, an ejector pin is advanced through drive of an ejection motor of an ejector apparatus, whereby the molded product is ejected and released from the mold.

Incidentally, in a molding machine management system for centrally managing a plurality of injection molding machines at a single location, a personal computer serving as a management apparatus is connected to each injection molding machine via a network, and data for operating each injection molding machine and data obtained through operation of each injection molding machine are centrally managed at the personal computer (see, for example, Patent Document 1).

Patent Document 1: Japanese Patent Application Laid-Open (kokai) No. 2001-293761.

### DISCLOSURE OF THE INVENTION

### Problems to be Solved by the Invention

However, in the above-described conventional molding machine management system, when the personal computer crashes for example, the data are highly likely to be lost, and protection of the data is difficult. Further, since communications must be carried out at all times between the personal computer and each injection molding machine, heavy communication loads are imposed on the network, the injection molding machines, etc.

An object of the present invention is to solve the above-mentioned problems in the conventional molding machine management system, and to provide a molding machine management system, a molding machine, a management apparatus, and a molding machine management method, which facilitate protection of data and can suppress communication loads imposed on a network, molding machines, etc.

### Means for Solving the Problems

In order to achieve the above object, a molding machine management system of the present invention includes a management apparatus for managing a plurality of molding machines.

The system comprises information recording processing means which records on a recording device reference data acquired by operating each molding machine; information manipulation processing means which performs predetermined processing on the reference data and actual data acquired by operating each molding machine to thereby obtain manipulated data; information transmission processing means which transmits the reference data to the management apparatus in advance and transmits the manipulated data to the management apparatus as needed; and information synthesis processing means which synthesizes the reference data and the manipulated data.

### EFFECTS OF THE INVENTION

According to the present invention, there is provided a molding machine management system which includes a management apparatus for managing a plurality of molding machines.

The system comprises information recording processing means which records on a recording device reference data acquired by operating each molding machine; information manipulation processing means which performs predetermined processing on the reference data and actual data acquired by operating each molding machine to thereby obtain manipulated data; information transmission processing means which transmits the reference data to the management apparatus in advance and transmits the manipulated data to the management apparatus as needed; and information synthesis processing means which synthesizes the reference data and the manipulated data.

In this case, the data obtained by operating each molding machine are recorded on the recording device of the molding machine. Accordingly, even when the management apparatus crashes, not all the data are lost, and protection of the data becomes easier.

Further, after the reference data are sent from each molding machine to the management apparatus, only the manipulated data should be sent from each molding machine to the management apparatus. Consequently, there is no need for performing communication between the management apparatus and each of the molding machines at all times.

Accordingly, it is possible to suppress communication loads imposed on a network, the molding machines, etc.

### BRIEF DESCRIPTION OF DRAWINGS

FIG. 1 is a diagram showing a molding machine management system according to an embodiment of the present invention.

FIG. 2 is a first representation illustrating a first example data management method according to the embodiment of the present invention.

FIG. 3 is a second representation illustrating the first example data management method according to the embodiment of the present invention.

FIG. 4 is a third representation illustrating the first example data management method according to the embodiment of the present invention.

FIG. 5 is a first representation illustrating a second example data management method according to the embodiment of the present invention.

FIG. 6 is a second representation illustrating the second example data management method according to the embodiment of the present invention.

### DESCRIPTION OF SYMBOLS

20: molding machine control system
22: main control section
24, 31: CPU
25, 32: RAM
26, 33: ROM
34: database
Mi: injection molding machine

### BEST MODE FOR CARRYING OUT THE INVENTION

An embodiment of the present invention will next be described in detail with reference to the drawings. Notably, there will be described a molding machine management system which centrally manages injection molding machines serving as molding machines.

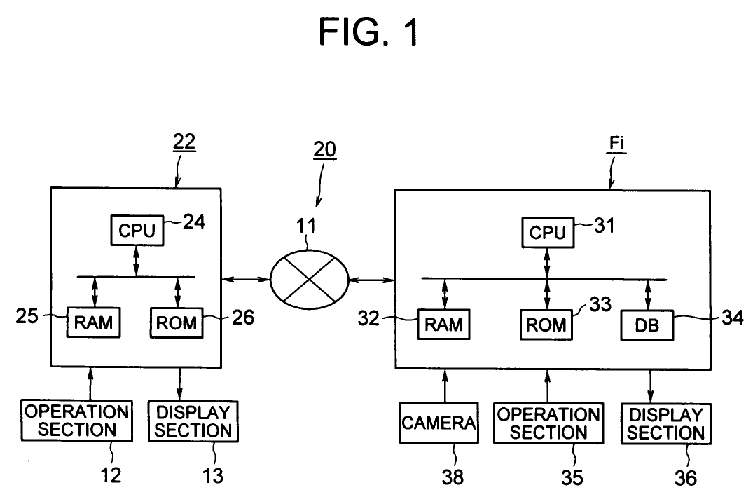

FIG. 1 is a diagram showing a molding machine management system according to the embodiment of the present invention.

In this drawing, 20 denotes a molding machine control system serving as a molding machine management apparatus; Mi (i=1, 2, . . . ) denotes a plurality of injection molding machines; 22 denotes a main control section serving as a management apparatus which centrally manages the injection molding machines Mi; Fi (i=1, 2, . . . ) denotes control sections of the injection molding machines Mi; and 11 denotes a network which connects the main control section 22 and the injection molding machines Mi. In the present embodiment, the main control section 22 functions as a management apparatus; however, the control section of at least one injection molding machine among the plurality of injection molding machines Mi may be configured to function as a management apparatus.

The main control section 22 includes a CPU 24 serving as an arithmetic unit; RAM 25 which is used as a working memory when the CPU 24 performs various types of arithmetic processing; ROM 26 which stores a control program and various data; etc. The main control section 22 is connected to an operation section 12 composed of an operation panel, a keyboard, or the like; and a display section 13 composed of a CRT, a liquid-crystal display, or the like. Each control section Fi includes a CPU 31 serving as an arithmetic unit; RAM 32 which is used as a working memory when the CPU 31 performs various types of arithmetic processing; ROM 33 which stores a control program and various data; etc. In addition, each control section Fi includes a database (DB) 34 for recording data obtained by operating each injection molding machine Mi. Each control section Fi is connected to an operation section 35 composed of an operation panel, a keyboard, or the like; a display section 36 composed of a CRT, a liquid-crystal display, or the like; and a camera 38 which serves as an image-capturing device for monitoring and which captures an image of a predetermined monitored portion of the injection molding machine Mi. The camera 38 captures an image of the monitored portion, and sends to the CPU 31 data (image data) representing the captured image of the monitored portion. Unillustrated image processing means (an image processing section) of the CPU 31 performs image processing so as to process the data of the image as needed to thereby obtain processed data of the image. Unillustrated information recording processing means (an information recording processing section) of the CPU 31 performs information recording processing so as to record the data of the image in the database 34 as is or record the processed data of the image in the database 34.

The above-described molding machine control system 20, the CPUs 24 and 31, etc. can be caused to function as a computer on the basis of various programs, data, etc. The database 34, the RAMs 25 and 32, the ROMs 26 and 33, etc. constitute a recording device. In place of the CPUs 24 and 31, an MPU or the like may be used.

Each of the injection molding machines Mi includes an unillustrated mold apparatus, an unillustrated mold-clamping apparatus, an unillustrated injection apparatus, etc. The mold-clamping apparatus includes a stationary platen and a movable platen. The movable platen is advanced and retreated through drive of a mold-clamping motor (a drive section for mold clamping) to thereby perform mold closing, mold clamping, and mold opening of the mold apparatus.

Meanwhile, the injection apparatus includes a heating cylinder (a cylinder member) for heating and melting resin (molding material) fed from a hopper, and an injection nozzle for injecting the molten resin. A screw is disposed in the heating cylinder such that the screw can rotate and can advance and retreat. When the screw is rotated through drive of a metering motor (a drive section for metering), metered resin is accumulated forward of the screw within the heating cylinder. When the screw is advanced through drive of an injection motor (a drive section for injection), the resin accumulated forward of the screw is injected and charged into a cavity of the mold apparatus in a clamped state.

When mold opening is performed after the resin within the cavity is cooled to complete a molded product, an ejector pin is advanced through drive of an ejection motor (a drive section for ejection) of an ejector apparatus, whereby the molded product is ejected and released from the mold.

Unillustrated monitor processing means (a monitor processing section) of the CPU 31 performs monitor processing so as to monitor actual values, such as temperature, pressure, speed, time, and position, while the injection molding machine Mi is operated. For example, as to temperature, heating cylinder temperature, mold temperature, resin temperature, etc. are monitored as actual values. As to pressure, injection pressure, mold-clamping force, screw back-pressure, resin pressure, holding pressure, etc. are monitored as actual values. As to speed, screw speed, mold open/close speed, screw rotational speed, etc. are monitored as actual values. As to time, charging time, pressure-holding time, cooling time, metering time, molding cycle time, etc. are monitored as actual values. As to position, screw position, pressure-holding end position, metering position, V-P changeover position, mold open/close position, etc. are monitored as actual values. Further, as to the charging time, there can be monitored, for example, a time duration between start of charging and start of pressure holding, a time duration between an arbitrary time and start of pressure holding, or the like. As the screw position, pre-charging screw position, cushion position, etc. can be monitored.

Unillustrated information acquisition processing means (an information acquisition processing section) of the CPU 31 performs information acquisition processing so as to calculate and obtain the above-described actual values; and the above-described information recording processing means records data representing the actual values in the database 34.

Incidentally, when the injection molding machines Mi are centrally controlled by means of the main control section 22, data for operating the injection molding machines Mi and data obtained through operation of the injection molding machines Mi may be centrally managed at the main control section 22. In this case, if the main control section 22 crashes, for example, the data are highly likely to be lost, and protection of the data is difficult. Further, since communications must be carried out at all times between the main control section 22 and each injection molding machine Mi, heavy communication loads are imposed on the network 11, the injection molding machines Mi, etc.

In consideration of the above, in the present embodiment, only necessary data are transmitted to the main control section 22 when necessary, and the remaining data are recorded in the database 34 and managed individually.

Next, there will be described a method of managing data acquired by photographing a molded product by use of the camera 38.

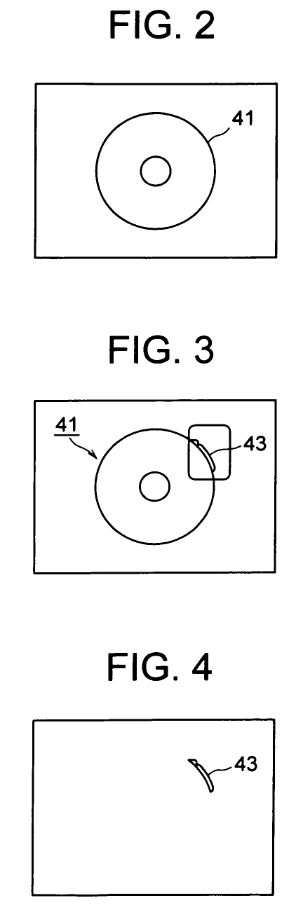

FIG. 2 is a first representation illustrating a first example data management method according to the embodiment of the present invention; FIG. 3 is a second representation illustrating the first example data management method according to the embodiment of the present invention; and FIG. 4 is a third representation illustrating the first example data management method according to the embodiment of the present invention.

In these drawings, reference numeral 41 denotes an image of a molded product, and 43 denotes an image of burrs formed on the molded product.

When a molded product produced by each injection molding machine Mi is non-defective, in the control section Fi (FIG. 1) of the injection molding machine Mi, the above-described information recording processing means records in the database 34, as reference data, data representing the image 41 of the molded product as shown in FIG. 2, which is photographed by the camera 38. Unillustrated information transmission processing means (an information transmission processing section) of the CPU 31 performs information transmission processing so as to transmit the data of the image 41 to the main control section 22 in advance. Notably, the information transmission processing means may be configured to read the reference data recorded in the database 34 and transmit the data to the main control section 22.

Meanwhile, in the main control section 22, unillustrated information reception processing means (an information reception processing section) of the CPU 24 performs information reception processing so as to receive the reference data transmitted from each injection molding machine Mi. Unillustrated reference-information recording processing means (a reference-information recording processing section) of the CPU 24 performs reference-information recording processing so as to record the received reference data in the ROM 26.

When a molded product produced by a certain injection molding machine Mi is defective; for example, when the molded product has burrs, the above-described information recording processing means records in the database 34, as actual data, data representing the image 41 of the molded product as shown in FIG. 3, which is photographed by the camera 38. At this time, the image 41 of the molded product includes the image 43 of the burrs.

Subsequently, unillustrated information comparison processing means (an information comparison processing section), which serves as information manipulation processing means (an information manipulation processing section), of the CPU 31 performs information comparison processing, which serves as information manipulation processing. That is, the information comparison processing means reads the actual data and the reference data from the database 34, and performs a preset processing on at least one of the actual data and the reference data to thereby obtain manipulated data (processed data). In the present embodiment, the information comparison processing means compares the actual data and the reference data to thereby obtain, as the manipulated data, data (i.e., differential data) of a differential image representing the difference between the image of the non-defective product and the image of the defective product. The differential data are represented by the image 43 of burrs shown in FIG. 4.

Next, the above-described information transmission processing means transmits the differential data to the main control section 22 as needed. When the main control section 22 receives the differential data from the injection molding machine Mi, unillustrated differential-information recording processing means (a differential-information recording processing section) of the CPU 24 performs differential-information recording processing so as to record the differential data in the ROM 26. Subsequently, unillustrated information synthesis processing means (an information synthesis processing section) of the CPU 24 performs information synthesis processing. That is, the information synthesis processing means reads the reference data from the ROM 26, and adds the reference data and the differential data together so as to combine the image 41 of the non-defective molded product shown in FIG. 2 with the image 43 of the burrs shown in FIG. 4, to thereby form an image 41 of the defective molded product shown in FIG. 3.

In the present embodiment, when a molded product produced by a certain injection molding machine Mi is defective, differential data are calculated and are automatically transmitted to the main control section 22. However, the present embodiment may be modified such that the differential data are transmitted to the main control section 22 in response to a differential-data transmission request from the main control section 22.

Next, there will be described a method for managing data obtained through monitoring performed by the monitoring processing means.

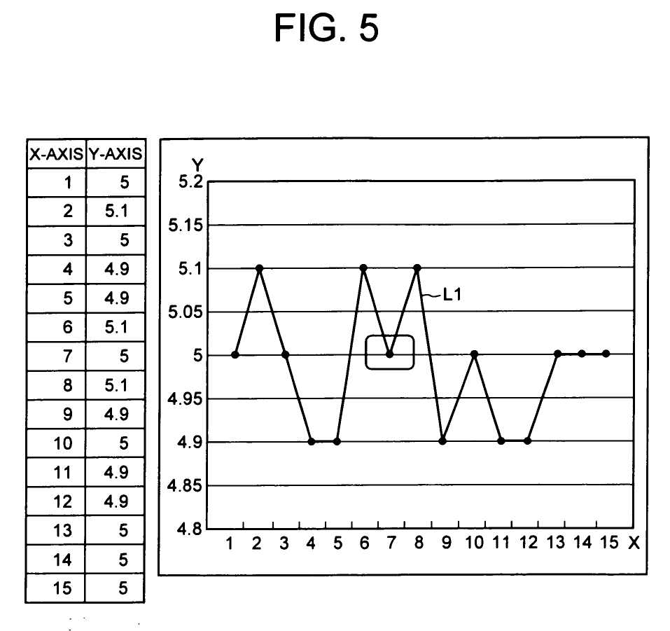

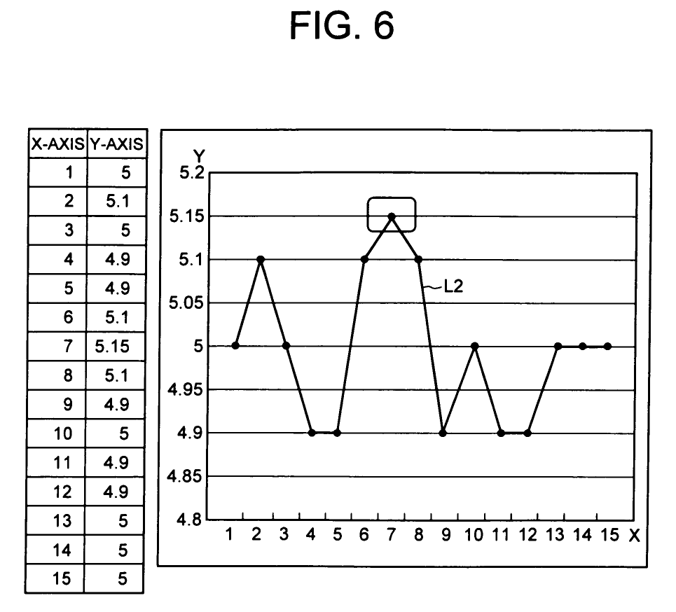

FIG. 5 is a first representation illustrating a second example data management method according to the embodiment of the present invention; and FIG. 6 is a second representation illustrating the second example data management method according to the embodiment of the present invention. In the case of the illustrated graphs, the X axis represents time, and the Y axis represents data of predetermined actual values. Notably, the X axis may represent position.

In these drawings, L1 and L2 are waveforms each representing a change in the actual value of a predetermined monitored item in a single shot when a predetermined molded product is produced.

When a molded product produced by each injection molding machine Mi is non-defective, in the control section Fi (FIG. 1) of the injection molding machine Mi, the above-described information recording processing means reads a sensor output sent from a predetermined sensor, and records in the database 34, as reference data, data representing the waveform L1 as shown in FIG. 5. The information transmission processing means transmits the reference data to the main control section 22. Notably, detection value of rotational speeds detected by speed detectors provided on the motors (serving as drive sections) and detection values of mold-clamping force, injection pressure, etc., detected by pressure detectors can be recorded as the above-described reference data. Further, in the present embodiment, data obtained at the time when a molded product is non-defective are used as the reference data; however, data at an arbitrary point in time may be used as the reference data.

Meanwhile, in the main control section 22, the above-described reference-information recording processing means records in the ROM 26 the reference data transmitted from each injection molding Mi.

When a molded product produced by a certain injection molding machine Mi is defective; for example, when the actual value has a peak at a point of 7 (X-axis) so that the actual value at that point has changed from 5 to 5.15, the above-described information recording processing means records in the database 34, as detection data and actual data, data representing the waveform L2 as shown in FIG. 6.

Subsequently, the information comparison processing means reads the actual data and the reference data from the database 34, and compares the actual data and the reference data so as to calculate differential data representing the difference between the actual data and the reference data.

Next, the above-described information transmission processing means transmits to the main control section 22 the differential data (in the present embodiment, a value obtained by subtracting 5 from 5.15; i.e., 0.15). In the main control section 22, the above-described differential-information recording processing means records in the ROM 26 the differential data transmitted from the injection molding machine Mi. Subsequently, the above-described information synthesis processing means reads the reference data from the ROM 26, and adds and combines the reference data and the differential data together to thereby obtain the actual value shown in FIG. 6, which is for the time when the defective product is molded.

As described above, the data obtained by operating each injection molding machine Mi are recorded in the database 34 of the injection molding machine Mi. Therefore, even when the main control section 22 crashes, not all the data are lost, and protection of the data becomes easier.

Incidentally, data of, for example, the waveform L1 are created on the basis of detection values obtained at predetermined sampling intervals. Therefore, as in the case of image data, the amount of such data is large, and when such data are transmitted to the main control section 22, a heavy load is imposed on each injection molding machine Mi. However, in the present invention, once the reference data are transmitted from each injection molding machine Mi to the main control section 22, only the differential data are required to be transmitted between the main control section 22 and each injection molding machine Mi. Consequently, there is no need for performing communication between the main control section 22 and each injection molding machine Mi at all times.

Accordingly, it is possible to suppress communication loads imposed on the network 11, the molding machines Mi, etc.

Moreover, it is possible not only to shorten communication time, but also to simplify the processing for displaying an image, a waveform, or the like on the display section 13. Therefore, an operator can readily recognize the displayed image, waveform, or the like.

Incidentally, as described above, data of, for example, the waveform L1 are created on the basis of detection values obtained at predetermined sampling intervals. Therefore, under some molding conditions, data obtained in a certain shot rarely coincide exactly with data obtained in a different shot. In consideration of this fact, the above-described data management method may be modified as follows. When a molded product is non-defective and data representing the waveform L1 as shown in FIG. 5 are obtained, data of a predetermined range (margin) are recorded, as reference data, in the database 34 on the basis of the data of the waveform L1; and only data deviating from the range are transmitted. In this case, upper and lower limits of the range are transmitted as the reference data; and data representing the difference between the actual data and the upper limit or the difference between the actual data and the lower limit are transmitted as the differential data.

Further, the present invention can be applied to the case where some items are monitored for quality control and data representing the items detected at a specific time point or position are extracted as logging data. In the case of logging data, data are extracted in advance. However, when the number of items for quality control increases, the amount of data increases accordingly, and the load imposed on each injection molding machine Mi increases when transmission is performed. In this case, in each injection molding machine Mi, with logging data at a predetermined time point being used as the reference data, logging data obtained thereafter may be compared with the reference data so as to obtain differential data. Further, even in the case of logging data, logging data within a previously set range may be used as the reference data. In this case, the maximum value and minimum value of a range for non-defective products, which are used for determining whether a molded product is non-defective or defective, may be used as the reference data.

In the present embodiment, information comparison processing is performed on the reference data and the actual data. However, the embodiment may be modified such that the information manipulation processing means performs predetermined processing on the actual data so as to calculate a process capability, and the information transmission processing means transmits the calculated process capability to the main control section 22. In this case, in the main control section 22, unillustrated management processing means (a management processing section) of the CPU 24 performs management processing so as to manage each injection molding machine Mi on the basis of the process capability transmitted from each injection molding machine Mi. The process capability is represented by the number of products molded per unit time, which is obtained by dividing the total number of molded products by production time.

Alternatively, the embodiment may be modified such that the information manipulation processing means performs predetermined processing on the actual data so as to calculate an operating ratio, and the information transmission processing means transmits the calculated operating ratio to the main control section 22. In this case, in the main control section 22, the above-described management processing means manages each injection molding machine Mi on the basis of the operating ratio transmitted from each injection molding machine Mi. The operating ratio is represented by a value obtained by dividing a time during which full-automatic operation was performed by the total operation time.

The present invention is not limited to the above-described embodiment. Numerous modifications and variations of the present invention are possible in light of the spirit of the present invention, and they are not excluded from the scope of the present invention.

### INDUSTRIAL APPLICABILITY

The present invention is applicable to a molding machine management system which includes a plurality of injection molding machines.

1. A molding machine management system including a management apparatus for managing a plurality of molding machines, the system comprising:
(a) an information recording processing section which records on a recording device reference data acquired by operating each molding machine;
(b) an information manipulation processing section which performs predetermined processing on the reference data and actual data acquired by operating each molding machine to thereby obtain manipulated data;
(c) an information transmission processing section which transmits the reference data to the management apparatus in advance and transmits the manipulated data to the management apparatus as needed; and
(d) an information synthesis processing section which synthesizes the reference data and the manipulated data.

2. A molding machine management system according to claim 1, wherein the information manipulation processing section compares the reference data and the actual data so as to calculate differential data.

3. A molding machine management system according to claim 1, wherein each of the reference data and the actual data is data of an image.

4. A molding machine management system according to claim 1, wherein each of the reference data and the actual data is data of a waveform representing an actual value.

5. A molding machine which transmits data to a management apparatus which manages a plurality of molding machines, the molding machine comprising:
(a) an information recording processing section which records on a recording device detection data acquired by operating the molding machine;
(b) an information manipulation processing section which performs predetermined processing on the detection data; and
(c) an information transmission processing section which transmits to the management apparatus processed data obtained through the processing.

6. A molding machine according to claim 5, wherein the information manipulation processing section performs the processing on previously set reference data and the detection data.

7. A molding machine according to claim 5, wherein the information manipulation processing section calculates a process capability on the basis of the detection data.

8. A molding machine according to claim 5, wherein the information manipulation processing section calculates an operating capability on the basis of the detection data.

9. A molding machine management apparatus for managing a plurality of molding machines, the apparatus comprising an information reception processing section which receives processed data which are obtained through performance of predetermined processing on detection data acquired by operating each of the molding machines.

10. A molding machine management method for a molding machine management system including a management apparatus for managing a plurality of molding machines, the method comprising the steps of:
(a) recording on a recording device reference data acquired by operating each molding machine;
(b) performing predetermined processing on the reference data and actual data acquired by operating each molding machine to thereby obtain manipulated data;
(c) transmitting the reference data to the management apparatus in advance and transmitting the manipulated data to the management apparatus as needed; and
(d) synthesizing the reference data and the manipulated data.
